(19) United States
(12) Patent Application Publication
(10) Pub. No.: US 2026/0141817 A1
(43) Pub. Date: May 21, 2026

(54) System and Method of Facilitating Critical Reasoning Experiential Training for Professionals in the Child Welfare System

(71) Applicants: Kevin Marino, Tallahassee, FL (US); Robert James Wright, Boston, MA (US)

(72) Inventors: Kevin Marino, Tallahassee, FL (US); Robert James Wright, Boston, MA (US)

(21) Appl. No.: 18/951,386

(22) Filed: Nov. 18, 2024

Related U.S. Application Data
(60) Provisional application No. 63/599,914, filed on Nov. 16, 2023.

(51) Int. Cl. G09B 5/02; G06Q 50/22

(52) U.S. Cl. CPC G09B 5/02; G06Q 50/22

(57) ABSTRACT

A system and method of facilitating critical reasoning experiential training for professionals in the child welfare system is disclosed. The overall process of the method begins by relaying a pre-administrative tethering (AT) survey to a user computing device. The user account is prompted to enter survey answers for the pre-AT survey. The survey answers are compiled and relayed to the remote server. A critical reasoning (CR) training module generates a training session based on the survey answers for the pre-AT survey. The generated training session is relayed to the user computing device. The user account is prompted to perform the training session. A post-AT survey is relayed to the user computing device, if the training session is completed. The user account is prompted to enter survey answers for the post-AT survey, which are collected and relayed to the remote server, if the survey answers for the post-AT survey are entered.

### FIELD OF THE INVENTION

The present invention relates generally to group training systems and teaching methodologies. More specifically, the present invention discloses novel means of teaching professionals working in the child welfare system critical reasoning using experiential training.

### BACKGROUND OF THE INVENTION

The lack of cultivated solutions required to produce the necessary level of critical thinking and staff retention in the child welfare system requires novel solutions that can help professionals and organizations more efficiently and professional perform in such a way that children and families are greatly benefited. The present invention has been designed to address this issue by teaching professionals in the child welfare system better decision-making and other essential skills necessary to efficiently perform their job duties. In addition, the present invention helps train professionals to retain essential practice skills that can help them perform their everyday duties. Furthermore, the present invention helps improve worker resilience to secondary stress and trauma in the child welfare system so that workers can keep performing their job duties.

To do so, the present invention provides a system and method that applies new management methodologies. The present invention applies a specific blend of Administrative Tethering (AT), which includes pre-and post-assessments of relational bonds amongst employees in an organization. In addition, the present invention includes intentional bonding activities, preferably referred to as enactments, that are used to strengthen emotional intelligence and weakened bonds identified using AT. Further, the present invention includes structured critical reasoning tools and experiential learning modalities, such as simulations, which provide a structured dosage of reality placing the child welfare professional's brain in “crisis.” Overall, the present invention increases accurate decisions and retain child welfare professionals working for longer in the system. Additional features and benefits of the present invention are further discussed in the sections below.

### SUMMARY OF THE INVENTION

The present invention discloses a system and method of facilitating critical reasoning experiential training for professionals in the child welfare system. The present invention provides novel means to improve the child welfare system with targeted training for employees working in organizations involved in the system. To accomplish this, the system of the present invention implements real-time measurements taken throughout the training process to create an impossible task for the human brain to calculate. The data collection instruments and variables coupled with the real-time measurements increases the impossible task of human computation to manually calculate the movements in the training system of the present invention. The participants'biological measurements are taken in real-time just before the training series begins and concludes the last day of training. All measurements are combined and calibrated by the system to produce the most realistic assessment of the professionals'perceptual and actual demonstration of knowledge, ability, and skill pertaining to cognitive and affective engagement and decision-making as it relates ultimately back to the objective of keeping children safe and building resilient families in the child welfare system.

### BRIEF DESCRIPTION OF THE DRAWINGS

FIG. 1 is a block diagram showing the overall system of the present invention.

FIG. 2 is a flowchart showing the overall process of the method of the present invention.

FIG. 3 is a flowchart showing a continuation of the overall process of the method of the present invention.

FIG. 4 is a flowchart showing the subprocess of rating the survey sections of the pre-AT survey.

FIG. 5 is a flowchart showing the subprocess of determining survey sections in need of intervention and generating experience enactments for said survey sections.

FIG. 6 is a flowchart showing the subprocess of outputting experiential enactments and learning activities during the training session.

FIG. 7 is a flowchart showing the subprocess of facilitating the co-training between the user and a certified trainer.

FIG. 8 is a flowchart showing the subprocess of facilitating the supervised training of the user.

FIG. 9 is a flowchart showing the subprocess of tracking the user's anxiety levels.

FIG. 10 is a flowchart showing the subprocess of providing feedback to the user.

### DETAIL DESCRIPTIONS OF THE INVENTION

All illustrations of the drawings are for the purpose of describing selected versions of the present invention and are not intended to limit the scope of the present invention.

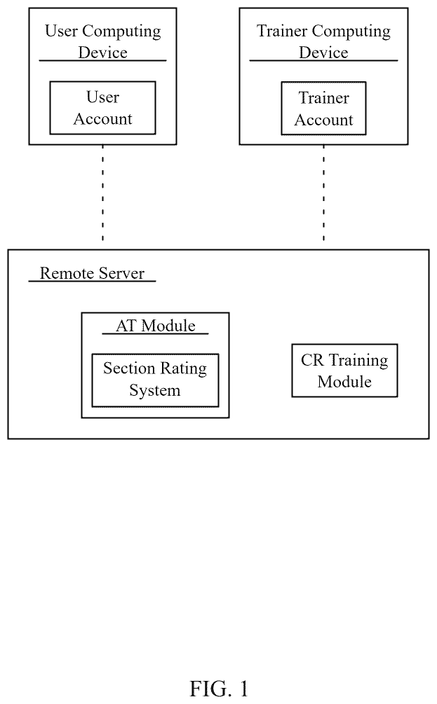

The present invention discloses a system and method of facilitating critical reasoning experiential training for professionals in the child welfare system. The present invention facilitates the implementation of a training program that teaches critical reasoning to professionals working in the child welfare system. As can be seen in FIG. 1, the system of the present invention is designed to facilitate the implementation of the method of the present invention. In general, the present invention can enable the physical implementation of the method as a traditional training program (seminar, in-person training, etc.). However, the present invention is preferably implemented as a software platform that enables the different process involved in the training program to be performed by all involved users using appropriate computing devices. The system of the present invention preferably includes at least one user account managed by at least one remote server (Step A). The user account corresponds to the account created by the professional to interact with and access the resources of the software platform, which is hosted on the remote server. Further, the user account is associated with a corresponding user computing device, which is any computing device that allows the user to connect to the software platform including, but not limited to, a smartphone, a tablet computer, a laptop, a desktop computer, etc. Furthermore, the software platform can include a software application that facilitates the access to the software platform through the corresponding user computing device. The software application can be developed in different versions to operate in the desired computing device in the form of a mobile application, desktop application, cloud application, etc.

As previously discussed, the present invention includes different tools that facilitate the implementation of the desired training program. As can be seen in FIG. 1, the remote server includes an administrative tethering (AT) module and a critical reasoning (CR) training module. The AT module is designed to assess the user's relational bonding between co-workers, supervisors, managers, leaders, and the children and families the user serves in the child welfare system. Administrative Tethering™ addresses collaboration, change, and implementation by exploring the health of relationships among the professionals working in child welfare systems. As such, when an extensive system operationalizes colossal change statewide, all network members must be adequately bonded together to make the necessary changes. Otherwise, the change can bound the members'rationality as well as accelerate change fatigue, reducing healthy critical reasoning.

Furthermore, the AT module measures the bonds between external agencies that collaborate in the system to fulfill a singular mission: to keep children safe and families preserved when possible. Critical thinking is impacted by a singular agency culture as well as the culture of the system. The AT module measures the relational bonds to determine where rationality is bound to determine how the critical reasoning training method of the present invention must be applied to improve the condition and culture of the organization, which in turn will improve critical reasoning. Further, the AT module includes a plurality of pre-AT surveys and a plurality of post-AT surveys that facilitate the measurement of different user factors that can be utilized by the CR training module to generate the appropriate training for the user. Furthermore, the CR training module includes a plurality of training sessions that efficiently train the user's critical reasoning through experiential training.

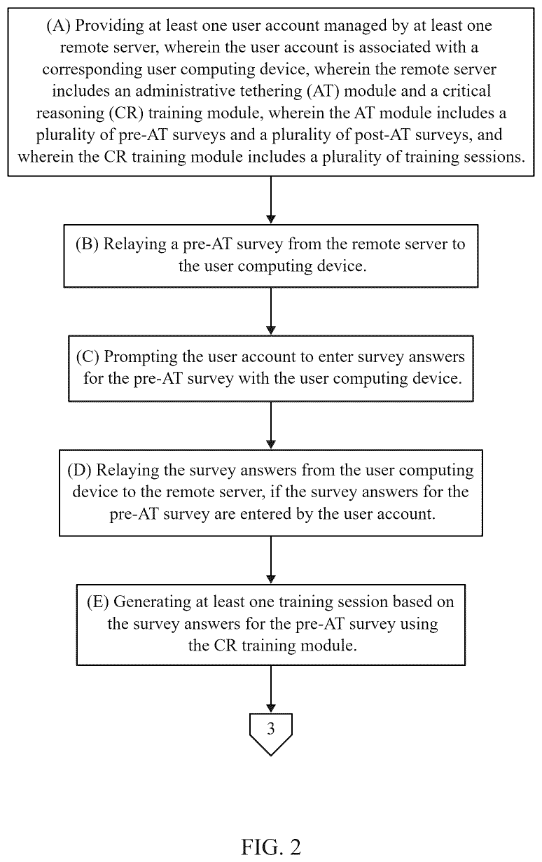

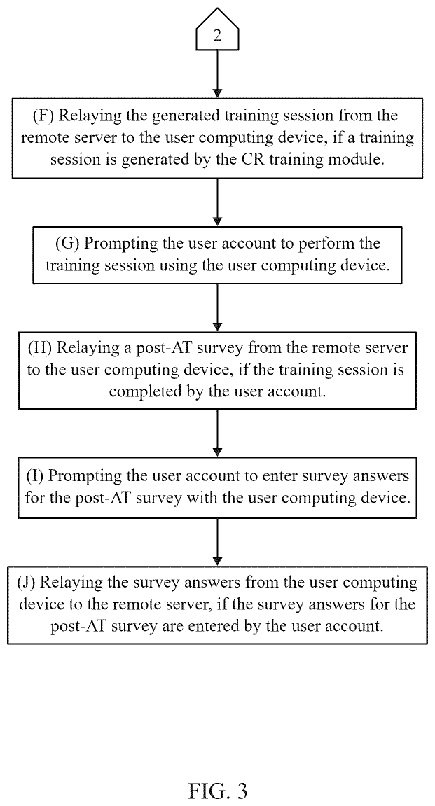

As can be seen in FIGS. 2 and 3, the method of the present invention assesses the user's relationship with an organization, practice, and the user's client. The overall process of the method begins by relaying a pre-AT survey from the remote server to the user computing device (Step B). The pre-AT survey enables the collection of measurements that assist in understanding potential impact areas of individual and organizational silos and the degree of distal relationships between the Department of Children and Families (DCF), the Sheriff's Office (SO), Community-Based Care (CBC), and other organizations expressed in variations of practice and adherence to policy. Once the pre-AT survey is relayed to the user computing device, the user account is prompted to enter survey answers for the pre-AT survey with the user computing device (Step C). The survey answers are compiled and relayed from the user computing device to the remote server (Step D), if the survey answers for the pre-AT survey are entered by the user account.

Through qualitative and quantitative data collection, the AT module examines the user's perception of the strength of the user's bonds with the user's organization, competence, confidence, and organizational climate. The AT module can provide key inferences, which assist in identifying areas to address bounded rationality to foster a climate and culture for critical reasoning. As can be seen in FIGS. 2 and 3, the CR training module generates at least one training session based on the survey answers for the pre-AT survey (Step E). The training session is especially designed to address the areas that are determined to show issues that may impede the efficiency of the user's work in the child welfare system. Further, the generated training session is relayed from the remote server to the user computing device (Step F), if a training session is generated by the CR training module. Once the user receives the training session, the user account is prompted to perform the training session using the user computing device (Step G). The user performs the training session according to the training program catered to the user's and the user's organization needs. Further, a post-AT survey is relayed from the remote server to the user computing device (Step H), if the training session is completed by the user account. The post-AT survey is used to collect data to measure the potential improvements in the bonding areas indicated as areas of bounded rationality. Like the pre-AT survey, the user account is prompted to enter survey answers for the post-AT survey with the user computing device (Step I), which are collected and relayed from the user computing device to the remote server (Step J), if the survey answers for the post-AT survey are entered by the user account.

Generally, AT has four core characteristics that are examined to evaluate the overall health of the organization: Trust, Value, Accountability, and Motivation. So, the pre-AT survey is divided into 12 sections that connect back to the four essential characteristics of a healthy organization. So, each pre-AT survey includes a plurality of survey sections corresponding to the 12 sections of the pre-AT survey. In the preferred embodiment, the plurality of survey sections includes, but is not limited to, an agency goal alignment section, a supervisor effectiveness section, an individual benefits section, a stay factor/retention section, an organizational communication section, a workplace safety section, an individual perceived self-value section, a teamwork section, an individual contribution section, a senior leadership trust section, a general job satisfaction section, a coworkers trust section, or a combination thereof. In addition, a grading scale is implemented to help quantitatively identify areas that need to be addressed for bounded rationality. Thus, the AT module is provided with a section rating system that includes a score scale with a plurality of section scores. In the preferred embodiment, the score scale is a zero to five scale, where zero corresponds to a level where the user is rationally stuck and there are unhealthy organizations/collaborations, and where five corresponds to a level where the user is rationally curious or in a state of near decomposability fostered by an adaptive organization.

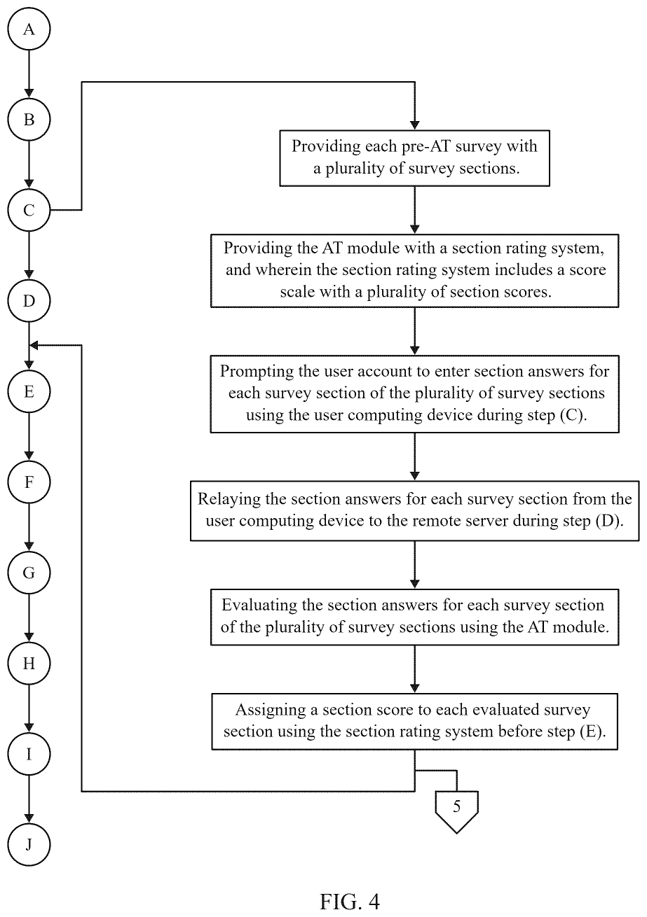

As can be seen in FIG. 4, the subprocess of rating the survey sections of the pre-AT survey includes the steps of prompting the user account to enter section answers for each survey section of the plurality of survey sections using the user computing device during Step C. The user is guided while completing the pre-AT survey so that the user can provide answers for each of the survey sections. Once the pre-AT survey is completed, the section answers for each survey section are relayed from the user computing device to the remote server during Step D. The survey answers for each survey section are examined to determine section score for each survey section. So, the section answers for each survey section of the plurality of survey sections are evaluated using the AT module, and a section score is assigned to each evaluated survey section using the section rating system before Step E. Each section score is logged and tallied by the remote server to determine which survey sections, and the corresponding areas need to be addressed during the training session.

Once the pre-AT survey reveals the areas of bounded rationality and distal relationships, the training session is modified to address trust, value, accountability, and motivation. To help determine which areas need to be addressed, the score scale includes at least one threshold passing score that helps determined the survey sections that need intervention. In the preferred embodiment, the threshold passing score is a 3.0, so any section score equal to or lower than 3.0 would correspond to a survey section that needs intervention. Once the survey sections that need to be addressed are determined, the critical reasoning and simulation training session is generated so that the survey sections in need of intervention are strengthened to achieve higher-quality bonding among the organizations or system's members. Bonding improvements among organizational members happen when bounded rationality is confronted through the critical reasoning training session. In addition, each training session of the plurality of training sessions includes a plurality of experience enactments. The critical reasoning training session utilizes experience enactments in an intentional process to break down bonded rationality and position the user, the user's team, the user's organization, and the collaborative system into a state of near decomposability. The position and state of near decomposability allow new thoughts and change to occur in the user and the user's organization. When child welfare employees are in a state and position of near decomposability, employees adhere to the policy, law, and practice models to make safe and healthy decisions for children and families.

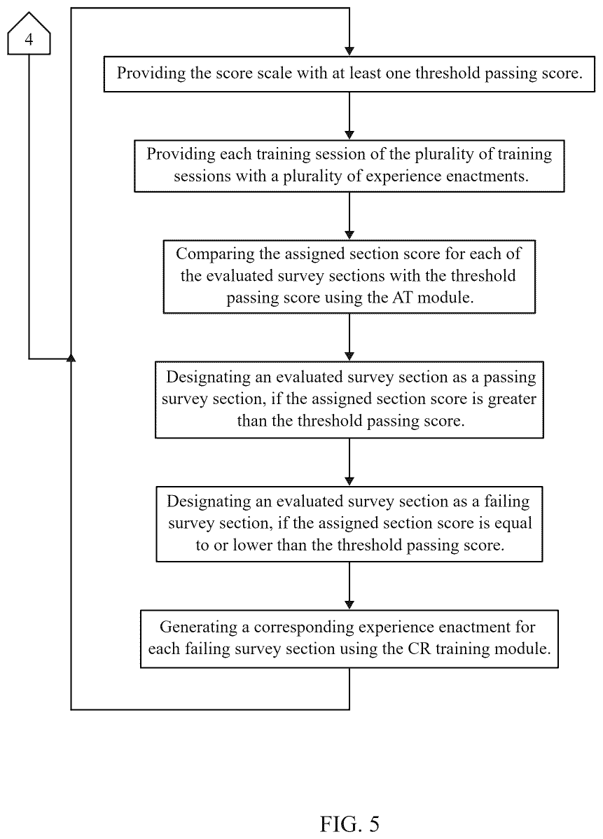

As can be seen in FIG. 5, the subprocess of determining survey sections in need of intervention and generating experience enactments for said survey sections includes the steps of comparing the assigned section score for each of the evaluated survey sections with the threshold passing score using the AT module. This way, every survey section is analyzed using the threshold passing score as a basis to determine which sections need to be addressed. Further, an evaluated survey section is designated as a passing survey section, if the assigned section score is greater than the threshold passing score. In other words, any survey section with a section score higher than 3.0 is not in need of intervention. Alternatively, an evaluated survey section is designated as a failing survey section, if the assigned section score is equal to or lower than the threshold passing score. In other words, if the assigned section score is equal to or lower than 3.0, the survey section is designated as in need of intervention. Once every survey section has been analyzed, a corresponding experience enactment is generated for each failing survey section using the CR training module. Finally, the generated experience enactments are compiled into the training session for the user to perform prior to Step G. In other embodiments, different scoring methods can be implemented to determine the areas that need to be addressed.

As previously discussed, the experiential enactments are designed to foster safe places for sharing experiences in child welfare practices. In the preferred embodiment, an experiential enactment is an evocation of lived experience promoting the user to share with a group and the trainers. The experiential enactments typically starts with asking the group, “Why do you do or stay in child welfare?” The experiential enactments aim to create safe vulnerability to accomplish two objectives: 1) to break down bounded rationality, and 2) to address secondary stress and trauma, which create bounded rationality. Once the experiential enactments are created, the training session is relayed to the user for completion.

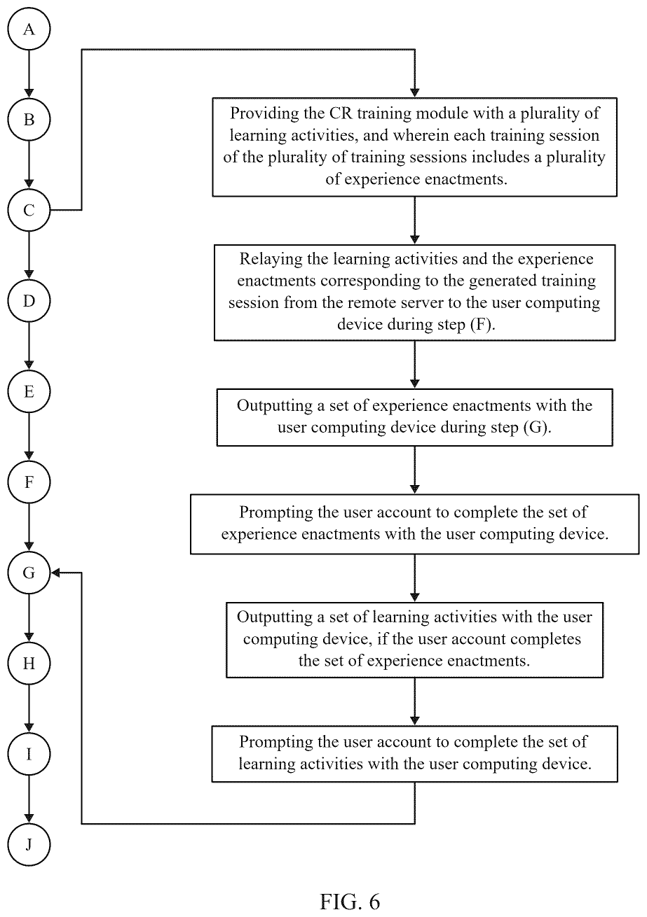

In the preferred embodiment, the training session is organized to be performed by the user over a period of 17 days. Further, the training session is divided into two training sections: enactment and learning training and experiential and simulation training. Enactment and learning training preferably includes two days of enactments and learning the process by implementing different learning tools for the user. So, the CR training module is provided with a plurality of learning activities. As can be seen in FIG. 6, the subprocess of outputting experiential enactments and learning activities during the training session includes the steps of relaying the learning activities and the experience enactments corresponding to the generated training session from the remote server to the user computing device during Step F. The learning activities and the experience enactments are designed to target the survey sections that have been identified to be in need of intervention. Then, a set of experience enactments with the user computing device during Step G, which the user account is prompted to complete with the user computing device. Afterwards, a set of learning activities is output with the user computing device, if the user account completes the set of experience enactments. The user account is prompted to complete the set of learning activities with the user computing device to complete the training session.

By implementing the sequential output of the experiential enactments and learning activities, the training session can be more effective. As previously discussed, the enactment and learning training section is performed over two days. So, a first set of experience enactments and a first set of learning activities is outputted during a first period of time, while a second set of experience enactments and a second set of learning activities is outputted during a second period of time. Further, the first period of time and the second period of time occur in a chronological sequence, wherein the first period of time is the first day of the enactment and learning training, and the second period of time is the second day. In other words, the first set of experience enactments and the first set of learning activities are performed during the first day of the training section, and the second set of experience enactments and the second set of learning activities are performed during the second day.

In the preferred embodiment, each day of the enactment and learning training section starts with one of the designed experiential enactments to open the room for sharing and bonding. Then, the user is provided with the learning activities to perform each day. The learning activities include, but are not limited to, a behavioral branch activity that includes teaching a four-word mnemonic device, a good call tool that involves visually mapping decisions, and a nexus tool that lists statements and observations input by the user account to facilitate the recognition of biases in the information. In the behavioral branch activity, a mnemonic device is taught to the user to memorize: Recognize, Examine, Interpret, and Review. This simple four-word process provides a framework for slowing the brain down to foster gathering information in child welfare work, learn to critically reason through the information and generate questions that clarify the information, use the authoritative filter of child welfare law and policy to further clarify if the information aligns with legal definitions of child maltreatment and parental protective factors, and use group-think in the review stage to promote bonding and ensure the decision is the most accurate based on the information gathered at this time. The good call tool is then used to map the decision on a worksheet or electronic form provided on the user computing device. The mnemonic device is followed and written out, activating the visual senses of the user. The written step visually represents the user's rationality and a decision map of the user's critical reasoning. Further, the good call tool mapping elicits facts from a child welfare case or any other decision the agency attempts to make. The facts listed in the review section of the good call tool are then written into the nexus tool. The nexus tool lists statements and observations the user writes down and lists recognized biases in the information. Bias can be recognized by the user or during group think in the review stage.

The repetitive nature of the process and tools follow the three-stage classical learning methodology of grammar, logic, and rhetoric stages. When the user gathers information, the user's brain is in the grammar stage, learning what the information is and how to organize the information. The method of the present invention provides a structure to move the professional's brain through this process sequentially to render a well-informed decision. In the information gathering stage (grammar stage), the user must learn to decide what is relevant versus what is not relevant, authoritative source for defining what is relevant is the child welfare policy, law, and practice. The user learns policy, law, and practice by applying the method of the present invention daily to improve knowledge and application (logic stage). Further, group think consensus reinforces confidence and competence in critical reasoning (rhetoric stage) and decisions become more accurately curated from child welfare law, policy, and practice models. Furthermore, the critical reasoning process and tools also focus on bias detection. Bias is any thought or feeling that can reduce objective decision-making. Bias is the natural way cognitive and affective processing works to define objects and interactions people encounter. For example, a learning activity can involve two to five pictures and objects the user is more than likely not to know the answers to and ask: “What is this?” This process allows biased teaching to come forward, and the user demonstrate a stronger ability to identify bias and improve decision-making.

After the enactment and learning training section is completed, the user is presented with the experiential and simulation training section. During the experiential and simulation training section, the method of the present invention utilizes the “See One, Do One, Teach One” methodology. The user is trained individually during the enactment and learning training section. Then, during the experiential and simulation training section, the user co-trains with certified trainers, and lastly, the user trains a third group as the certified trainers observe and score the user's proficiency. To facilitate the co-training portion of the experiential and simulation training section, at least one trainer account managed by the remote server is provided to enable the certified trainers to interact with the user during the training. In addition, the trainer account is associated with a corresponding trainer computing device just like the user computing device to enable the certified trainer to interact with the software platform. Further, each training session of the plurality of training sessions includes a plurality of co-training simulations for the user to perform along with the certified trainers.

During the experiential and simulation training section, different resilience skills are taught to help the user perform in the system. The user is taught breathing techniques studied to provide the most benefit for physical, emotional, and psychological recovery from stressful situations. In the preferred embodiment, the breathing technique involves one minute of deep breathing. Inhaling for five seconds while counting slowly and exhaling while counting to five slowly. Further, each count interval from one to two lasts for three seconds. This breathing exercise is performed before the simulation and directly after for best results.

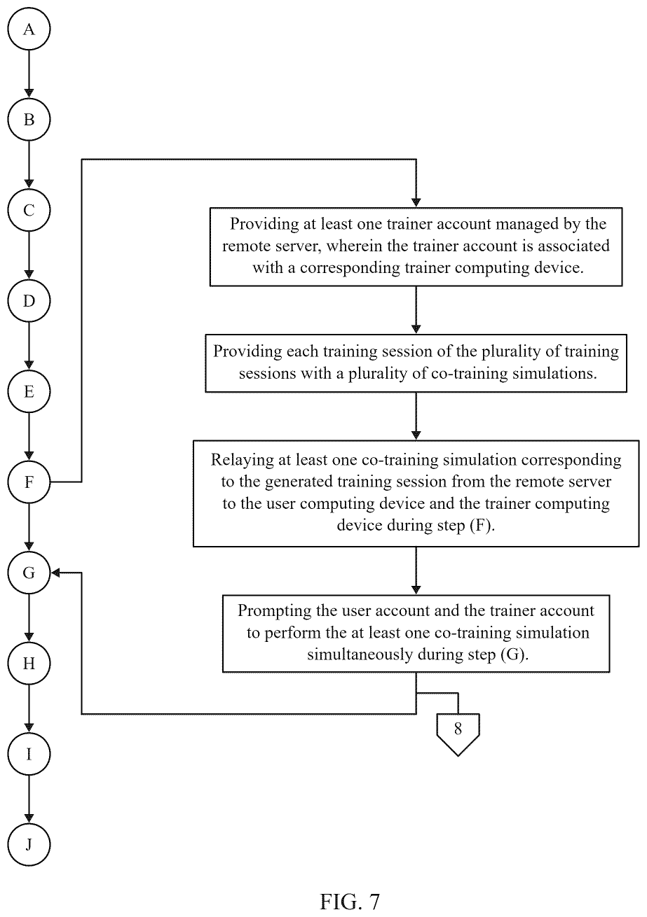

As can be seen in FIG. 7, the subprocess of facilitating the co-training between the user and a certified trainer includes the steps of relaying at least one co-training simulation corresponding to the generated training session from the remote server to the user computing device and the trainer computing device during Step F. This way, the user and the certified trainer can have access to the co-training simulation. Further, the user account and the trainer account are prompted to perform the at least one co-training simulation simultaneously during Step G so that both the user and the certified trainer participate during the co-training simulation.

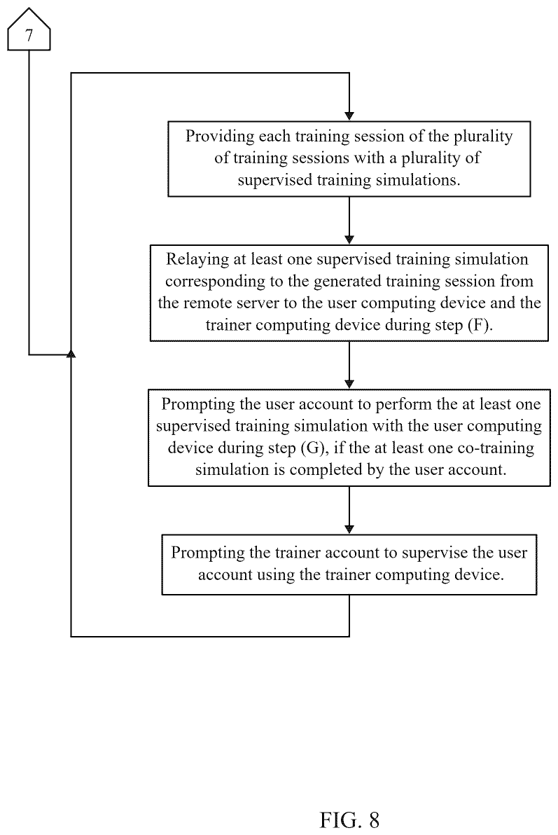

Similarly, during the supervised training portion of the experiential and simulation training section, the certified trainer is allowed to supervise the user without directly participating in the training simulation. So, the plurality of training sessions includes a plurality of supervised training simulations. As can be seen in FIG. 8, the subprocess of facilitating the supervised training of the user includes the steps of relaying at least one supervised training simulation corresponding to the generated training session from the remote server to the user computing device and the trainer computing device during Step F. This way, the user can perform the supervised training simulation, and the certified trainer can supervise the training. Further, the user account is prompted to perform the at least one supervised training simulation with the user computing device during Step G, if the at least one co-training simulation is completed by the user account. In other words, the user must first complete the co-training simulation before performing the supervised training simulation. Furthermore, the trainer account is prompted to supervise the user account using the trainer computing device. In other embodiments, different training simulations can be implemented for the user that involves the certified trainer at different levels.

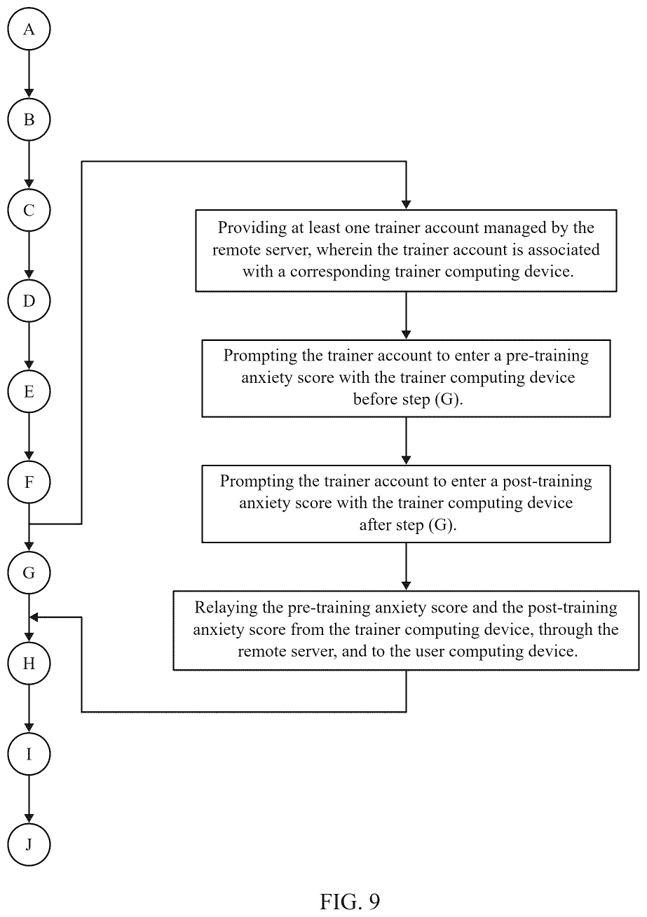

Further, during the experiential and simulation training section, the certified trainers are prompted to track the progress of the user's behavior during the different training simulations using different behavioral factors. One of the main behavioral factors tracked is the user's anxiety levels which are tracked throughout the user's training. As can be seen in FIG. 9, the subprocess of tracking the user's anxiety levels includes the steps of prompting the trainer account to enter a pre-training anxiety score with the trainer computing device before Step G. The initial anxiety levels serve as a base to measure the user's progress after completing the training session. After completing the training session, the trainer account is prompted to enter a post-training anxiety score with the trainer computing device after Step G. Afterwards, the pre-training anxiety score and the post-training anxiety score are relayed from the trainer computing device, through the remote server, and to the user computing device for the user to keep track of the progress.

In the preferred embodiment, the user is scaled on a one to ten scale, where ten is high anxiety, and one1 is no anxiety. The anxiety scores are generated before and after the simulation to compare scores. In addition, other behavioral factors can be tracked along with the anxiety levels. For example, the user can be rated on the user's perception of how real the training simulations were. Unlike the user's anxiety scores, the perceived reality score is completed after the simulation and after the breathing skills. Like the anxiety level scale, the perceived reality scaled is also ranked from one to ten, where ten corresponds to the training simulation being as real as working a child welfare case, and where one corresponds to the training simulation not being real. In other embodiments, different behavioral factors can be tracked and rated.

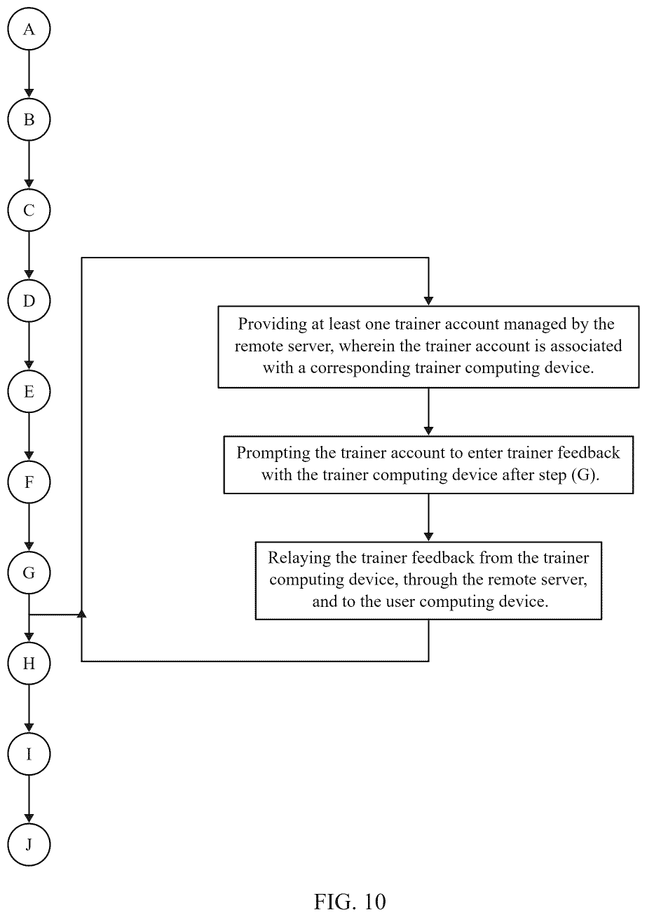

After the experiential and simulation training section is completed, feedback is provided to the user. As can be seen in FIG. 10, the subprocess of providing feedback to the user includes the steps of prompting the trainer account to enter trainer feedback with the trainer computing device after Step G. Different feedback can be obtained that covers different aspects of the user's training. For example, the feedback can include one strength and one challenge that was determined by the certified trainer. Further, other feedback can be provided from other users that participated in the training session. For example, three or four other users can be chosen to provide feedback. Afterwards, the trainer feedback is relayed from the trainer computing device, through the remote server, and to the user computing device for the user to read through. Feedback is provided after breathing, scaling for anxiety, and scaling for perceived reality. Feedback is formulated from the observations the certified trainer made of the user in the training simulation. For example, the certified trainer may say, “I observed you take 3 steps back from the father as his voiced raised to give yourself a safe position to avoid sudden advances that may cause you harm.” In other embodiments, different feedback can be provided to the user during different stages of the training session.

Further, during the experiential and simulation training section, the training simulations follow real-life sequencing and evokes real-life experiences via the use of simulation players (i.e., actors and actresses). In the preferred embodiment, the real-life sequence of the simulated case starts with a referral for abuse, neglect, or dependency. Then, the training simulation moves to knocking on a family's door to introduce the referral and professional, gathering information through step-by-step interviewing, creating a plan with the family to keep the children safe, crisis response and management when the safety plan does not work, going to court, and providing services to the family in attempts to keep the children with the family and practicing decisions if the children cannot be returned back to their parents. Further, four enactments are crafted and completed on the first, second, third, and fourth days of the 15-day experiential and simulation training section. Building emotional intelligence that targets the operation of empathy strengthens resilience to combat secondary stress and trauma. A total of 14 enactments are completed from the 2-day enactment and learning training section through the experiential and simulation training section.

Further, as the certified trainers learn about the user from the pre-AT survey and by making observations in the enactment portions of the training session, the certified trainers can strengthen the user's skills by communicating directly with the simulation players as the user participates in the training simulation. The certified trainers may send audio or visual signals to a simulation player to increase or decrease resistance. Adjusting resistance allows the user's experience to be maximized to aid in reaching actual potential and resilience levels. Further, at the beginning and end of each training day, the user is given the opportunity to think about how the user's experience has been so far during the training session. The discussion is required to provide training on how to process challenging interactions as a group or team in the child welfare system.

Although the invention has been explained in relation to its preferred embodiment, it is to be understood that many other possible modifications and variations can be made without departing from the spirit and scope of the invention.

1. A method of facilitating critical reasoning experiential training for professionals in the child welfare system, the method comprising the steps of:
(A) providing at least one user account managed by at least one remote server, wherein the user account is associated with a corresponding user computing device, wherein the remote server includes an administrative tethering (AT) module and a critical reasoning (CR) training module, wherein the AT module includes a plurality of pre-AT surveys and a plurality of post-AT surveys, and wherein the CR training module includes a plurality of training sessions;
(B) relaying a pre-AT survey from the remote server to the user computing device;
(C) prompting the user account to enter survey answers for the pre-AT survey with the user computing device;
(D) relaying the survey answers from the user computing device to the remote server, if the survey answers for the pre-AT survey are entered by the user account;
(E) generating at least one training session based on the survey answers for the pre-AT survey using the CR training module;
(F) relaying the generated training session from the remote server to the user computing device, if a training session is generated by the CR training module;
(G) prompting the user account to perform the training session using the user computing device;
(H) relaying a post-AT survey from the remote server to the user computing device, if the training session is completed by the user account;
(I) prompting the user account to enter survey answers for the post-AT survey with the user computing device; and
(J) relaying the survey answers from the user computing device to the remote server, if the survey answers for the post-AT survey are entered by the user account.

2. The method as claimed in claim 1 further comprising the steps of:
providing each pre-AT survey with a plurality of survey sections;
providing the AT module with a section rating system, and wherein the section rating system includes a score scale with a plurality of section scores;
prompting the user account to enter section answers for each survey section of the plurality of survey sections using the user computing device during step (C);
relaying the section answers for each survey section from the user computing device to the remote server during step (D);
evaluating the section answers for each survey section of the plurality of survey sections using the AT module; and
assigning a section score to each evaluated survey section using the section rating system before step (E).

3. The method as claimed in claim 2, wherein the plurality of survey sections includes an agency goal alignment section, a supervisor effectiveness section, an individual benefits section, a stay factor/retention section, an organizational communication section, a workplace safety section, an individual perceived self-value section, a teamwork section, an individual contribution section, a senior leadership trust section, a general job satisfaction section, a coworkers trust section, or a combination thereof.

4. The method as claimed in claim 2 further comprising the steps of:
providing the score scale with at least one threshold passing score;
providing each training session of the plurality of training sessions with a plurality of experience enactments;
comparing the assigned section score for each of the evaluated survey sections with the threshold passing score using the AT module;
designating an evaluated survey section as a passing survey section, if the assigned section score is greater than the threshold passing score;
designating an evaluated survey section as a failing survey section, if the assigned section score is equal to or lower than the threshold passing score; and
generating a corresponding experience enactment for each failing survey section using the CR training module.

5. The method as claimed in claim 1 further comprising the steps of:
providing the CR training module with a plurality of learning activities, and wherein each training session of the plurality of training sessions includes a plurality of experience enactments;
relaying the learning activities and the experience enactments corresponding to the generated training session from the remote server to the user computing device during step (F);
outputting a set of experience enactments with the user computing device during step (G);
prompting the user account to complete the set of experience enactments with the user computing device;
outputting a set of learning activities with the user computing device, if the user account completes the set of experience enactments; and
prompting the user account to complete the set of learning activities with the user computing device.

6. The method as claimed in claim 5, wherein a first set of experience enactments and a first set of learning activities is outputted during a first period of time, wherein a second set of experience enactments and a second set of learning activities is outputted during a second period of time, and wherein the first period of time and the second period of time occur in a chronological sequence.

7. The method as claimed in claim 5, wherein a learning activity of the plurality of learning activities is a behavioral branch activity, and wherein the behavioral branch activity includes teaching a four-word mnemonic device.

8. The method as claimed in claim 5, wherein a learning activity of the plurality of learning activities is a good call tool, and wherein the good call tool involves visually mapping decisions.

9. The method as claimed in claim 5, wherein a learning activity of the plurality of learning activities is a nexus tool, and wherein the nexus tool lists statements and observations input by the user account to facilitate the recognition of biases in the information.

10. The method as claimed in claim 1 further comprising the steps of:
providing at least one trainer account managed by the remote server, wherein the trainer account is associated with a corresponding trainer computing device;
providing each training session of the plurality of training sessions with a plurality of co-training simulations;
relaying at least one co-training simulation corresponding to the generated training session from the remote server to the user computing device and the trainer computing device during step (F); and
prompting the user account and the trainer account to perform the at least one co-training simulation simultaneously during step (G).

11. The method as claimed in claim 10 further comprising the steps of:
providing each training session of the plurality of training sessions with a plurality of supervised training simulations;
relaying at least one supervised training simulation corresponding to the generated training session from the remote server to the user computing device and the trainer computing device during step (F);
prompting the user account to perform the at least one supervised training simulation with the user computing device during step (G), if the at least one co-training simulation is completed by the user account; and
prompting the trainer account to supervise the user account using the trainer computing device.

12. The method as claimed in claim 1 further comprising the steps of:
providing at least one trainer account managed by the remote server, wherein the trainer account is associated with a corresponding trainer computing device;
prompting the trainer account to enter a pre-training anxiety score with the trainer computing device before step (G);
prompting the trainer account to enter a post-training anxiety score with the trainer computing device after step (G); and
relaying the pre-training anxiety score and the post-training anxiety score from the trainer computing device, through the remote server, and to the user computing device.

13. The method as claimed in claim 1 further comprising the steps of:
providing at least one trainer account managed by the remote server, wherein the trainer account is associated with a corresponding trainer computing device;
prompting the trainer account to enter trainer feedback with the trainer computing device after step (G); and
relaying the trainer feedback from the trainer computing device, through the remote server, and to the user computing device
